(19) United States
(12) Patent Application Publication
(10) Pub. No.: US 2026/0313204 A1
(43) Pub. Date: Oct. 8, 2026

(54) DISPLAY APPARATUS, METHOD FOR OPERATING THE SAME, AND COMPUTER-READABLE STORAGE MEDIUM

(71) Applicant: LG ELECTRONICS INC., Seoul (KR)

(72) Inventors: Hyangjin LEE, Seoul (KR); Jaekyung LEE, Seoul (KR); Eunkyoung HAN, Seoul (KR); Daegun PARK, Seoul (KR); Minkyeong SEO, Seoul (KR)

(73) Assignee: LG ELECTRONICS INC., Seoul (KR)

(21) Appl. No.: 19/567,762

(22) Filed: Mar. 16, 2026

(30) Foreign Application Priority Data
Apr. 7, 2025 (KR) 10-2025-0044961

(51) Int. Cl. H04N 21/488; H04N 21/462

(52) U.S. Cl. CPC H04N 21/4882; H04N 21/4622

(57) ABSTRACT

The present disclosure relates to a display apparatus and a method for operating the same, which are applicable to a technical field of a display apparatus and capable of improving user convenience related to content. A display apparatus according to an embodiment of the present disclosure includes a display and a controller configured to process an image signal and display the processed image signal on the display. The controller is configured to execute and display a customer support application on the display, provide information regarding the display apparatus through the customer support application, and further provide customer support content related to the display apparatus.

### CROSS-REFERENCE TO RELATED APPLICATIONS

A claim for priority under 35 U.S.C. § 119 is made to Korean Patent Application No. 10-2025-0044961 filed on Apr. 7, 2025 in the Korean Intellectual Property Office, the entire contents of which are hereby incorporated by reference.

### BACKGROUND

### 1. Technical Field

The present disclosure relates to a technical field of a display apparatus, and for example, to a display apparatus capable of improving user convenience related to content, a method for operating the same, and a computer-readable storage medium storing program instructions for causing a controller to perform operations.

### 2. Description of Related Art

Digital TV services using wired or wireless communication networks are becoming common. Digital TV services can provide various services that could not be provided by conventional analog broadcasting services.

For example, IPTV (Internet Protocol Television) and smart TV services, which are types of digital TV services, provide interactivity that allows users to actively select types of viewing programs, viewing times, and the like. Based on such interactivity, IPTV and smart TV services may provide various additional services, such as Internet search, home shopping, and online games.

A user may encounter a sudden software or hardware problem while watching such a digital TV. At this time, it may be difficult for the user to solve such a problem.

When such software or hardware problems occur, simultaneous and multiple user inquiries may arise, which may make it difficult to operate a normal customer support system.

Accordingly, a method for solving such problems is required.

### SUMMARY

An object of the present disclosure is to provide a display apparatus capable of easily providing customer support content related to the display apparatus, a method for operating the same, and a computer-readable storage medium.

Another object of the present disclosure is to provide a display apparatus capable of quickly providing frequently occurring customer service inquiries related to the display apparatus and responses to the inquiries, a method for operating the same, and a computer-readable storage medium.

Another object of the present disclosure is to provide a display apparatus that allows a user to easily submit a solution or content related to a software or hardware problem, a method for operating the same, and a computer-readable storage medium.

Another object of the present disclosure is to provide a display apparatus capable of reducing call waiting time when receiving customer support requests and quickly providing information during a consultation with a counselor, a method for operating the same, and a computer-readable storage medium.

According to an embodiment of the present disclosure, a display apparatus may include a display and a controller configured to process an image signal and display the processed image signal on the display, wherein the controller is configured to execute and display a customer support application on the display, provide information regarding the display apparatus through the customer support application, and further provide customer support content related to the display apparatus.

In an exemplary embodiment, the customer support content may include frequently occurring customer service inquiries related to the display apparatus and responses to the inquiries.

In an exemplary embodiment, the frequently occurring customer service inquiries and the responses to the inquiries may be provided as a notice of the customer support application.

In an exemplary embodiment, the responses may include at least one of a solution related to the frequently occurring customer service inquiries and guidance for a follow-up action.

In an exemplary embodiment, the controller may receive or update the customer support content related to the display apparatus.

In an exemplary embodiment, the customer support application may provide a tool for collecting an additional request from a user related to the customer support content.

In an exemplary embodiment, technical details specific to the display apparatus may be provided to the tool.

In an exemplary embodiment, the technical details specific to the display apparatus may include at least one of a model name, a serial number, and a software version of the display apparatus.

In an exemplary embodiment, the additional request from the user may be provided to a customer support operating system.

In an exemplary embodiment, the controller (or processor) may store, as a log, an item selected by the user in the customer support application and a history of actions taken by the user, analyze the collected log to generate summary information, and transmit the summary information to the customer support operating system.

In an exemplary embodiment, the customer support application may provide a tool for collecting an additional request from a user related to the customer support content.

In an exemplary embodiment, device information including at least one of a model name, a serial number, and a software version of the display apparatus may be provided to the tool.

In an exemplary embodiment, information on a previous repair history of the display apparatus related to the device information may be further provided to the tool based on the device information.

In an exemplary embodiment, customer information related to the display apparatus may be provided to the tool, and the customer information may be collected when the customer consents.

According to an embodiment of the present disclosure, a method for operating a display apparatus using a customer support application executed by a controller of the display apparatus in connection with a customer support operating system includes: receiving or updating customer support content related to the display apparatus from the customer support operating system; providing the customer support content related to the display apparatus and responses to inquiries; storing, as a log, an item selected by a user in the customer support application and a history of actions taken by the user; analyzing the collected log to generate summary information; and transmitting the summary information to the customer support operating system.

In an exemplary embodiment, the method may further include providing a tool for collecting an additional request from the user related to the customer support content.

According to an embodiment of the present disclosure, in a computer-readable storage medium storing program instructions for causing a controller to perform operations, the operations include: receiving or updating customer support content related to a display apparatus from a customer support operating system; providing the customer support content related to the display apparatus; storing, as a log, an item selected by a user in a customer support application and a history of actions taken by the user; analyzing the collected log to generate summary information; and transmitting the summary information to the customer support operating system.

### ADVANTAGEOUS EFFECTS

According to an embodiment of the present disclosure, the following effects are provided.

First, according to an embodiment of the present disclosure, customer support content related to a display apparatus can be easily provided.

In addition, frequently occurring customer service inquiries related to the display apparatus and responses to the inquiries can be quickly provided.

In addition, a user can easily submit a solution or content related to a software or hardware problem.

In addition, it is possible to reduce call waiting time when receiving customer support requests and to quickly provide information during a consultation with a counselor.

Furthermore, according to another embodiment of the present disclosure, there are additional technical effects not mentioned herein. Those skilled in the art can understand them through the entire context of the specification and drawings.

### BRIEF DESCRIPTION OF THE FIGURES

FIG. 1 is a block diagram illustrating a configuration of a display apparatus according to an embodiment of the present disclosure.

FIG. 2 is a block diagram of a remote control device according to an embodiment of the present disclosure.

FIG. 3 illustrates a practical configuration example of a remote control device according to an embodiment of the present disclosure.

FIG. 4 illustrates an example of utilizing a remote control device according to an embodiment of the present disclosure.

FIG. 5 is a block diagram of a detailed configuration of a display apparatus according to an embodiment of the present disclosure.

FIG. 6 is a ladder diagram illustrating an operating process of a display apparatus according to an embodiment of the present disclosure.

FIG. 7 is an exemplary diagram illustrating an example of a customer support application interface of a display apparatus according to an embodiment of the present disclosure.

FIG. 8 is a flowchart illustrating an operating process of a display apparatus according to an embodiment of the present disclosure.

FIG. 9 is an exemplary diagram illustrating an example of a customer support operating system associated with a display apparatus according to an embodiment of the present disclosure.

### DETAILED DESCRIPTION

Hereinafter, embodiments relating to the present disclosure will be described in detail with reference to the accompanying drawings. The suffixes “module” and “unit” for components used in the description below are assigned or mixed in consideration of easiness in writing the specification and do not have distinctive meanings or roles by themselves.

A display apparatus according to an embodiment of the present disclosure, for example, as an artificial display apparatus that adds a computer supporting function to a broadcast receiving function, may have an easy-to-use interface such as a writing input device, a touch screen, or a spatial remote-control device as an Internet function is added while fulfilling the broadcast receiving function. Then, with the support of a wired or wireless Internet function, it is possible to perform an e-mail, web browsing, banking, or game function in access to Internet and computers. In order to perform such various functions, standardized general purpose OS may be used.

Accordingly, since various applications are freely added or deleted on a general purpose OS kernel, a display apparatus described in the present disclosure, for example, may perform various user-friendly functions. The display apparatus, in more detail, may be a network TV, Hybrid Broadcast Broadband TV (HBBTV), smart TV, light-emitting diode (LED) TV, organic light-emitting diode (OLED) TV, and so on and in some cases, may be applied to a smartphone.

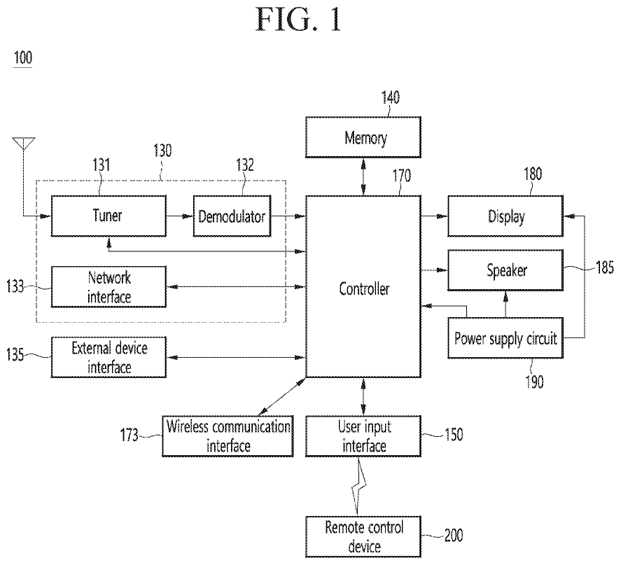

FIG. 1 is a block diagram illustrating a configuration of a display apparatus according to an embodiment of the present disclosure.

Referring to FIG. 1, a display apparatus 100 may include a broadcast reception module 130, an external device interface 135, a memory 140, a user input interface 150, a controller 170, a wireless communication interface 173, a display 180, a speaker 185, and a power supply circuit 190.

The broadcast reception module 130 may include a tuner 131, a demodulator 132, and a network interface 133.

The tuner 131 may select a specific broadcast channel according to a channel selection command. The tuner 131 may receive broadcast signals for the selected specific broadcast channel.

The demodulator 132 may divide the received broadcast signals into video signals, audio signals, and broadcast program-related data signals, and may restore the divided video signals, audio signals, and data signals into an output available form.

The external device interface 135 may receive an application or an application list in an adjacent external device and deliver the application or the application list to the controller 170 or the memory 140.

The external device interface 135 may provide a connection path between the display apparatus 100 and an external device. The external device interface 135 may receive at least one of an image and audio outputted from an external device that is wirelessly or wiredly connected to the display apparatus 100 and deliver the received image or the audio to the controller. The external device interface 135 may include a plurality of external input terminals. The plurality of external input terminals may include an RGB terminal, at least one High Definition Multimedia Interface (HDMI) terminal, and a component terminal.

An image signal of an external device inputted through the external device interface 135 may be outputted through the display 180. A sound signal of an external device inputted through the external device interface 135 may be outputted through the speaker 185.

An external device connectable to the external device interface 135 may be one of a set-top box, a Blu-ray player, a DVD player, a game console, a sound bar, a smartphone, a PC, a USB Memory, and a home theater system but this is just exemplary.

The network interface 133 may provide an interface for connecting the display apparatus 100 to a wired/wireless network comprising internet network. The network interface 133 may transmit or receive data to or from another user or another electronic device through an accessed network or another network linked to the accessed network.

Additionally, some content data stored in the display apparatus 100 may be transmitted to a user or an electronic device, which is selected from other users or other electronic devices pre-registered in the display apparatus 100.

The network interface 133 may access a predetermined webpage through an accessed network or another network linked to the accessed network. That is, the network interface 133 may transmit or receive data to or from a corresponding server by accessing a predetermined webpage through the network.

The network interface 133 may receive content or data provided from a content provider or a network operator. That is, the network interface 133 may receive content, such as movies, advertisements, games, VODs, and broadcast signals, which are provided from the content provider or the network operator, and information relating thereto through the network.

In addition, the network interface 133 may receive firmware update information and update files provided from the network operator, and may transmit data to the Internet or content provider or the network operator.

The network interface 133 may select and receive a desired application among applications open to the air, through network.

The memory 140 may store signal-processed image, voice, or data signals stored by a program in order for each signal processing and control in the controller 170.

In addition, the memory 140 may perform a function for temporarily storing image, voice, or data signals output from the external device interface 135 or the network interface 133, and may store information on a predetermined image through a channel memory function.

The memory 140 may store an application or an application list input from the external device interface 135 or the network interface 133.

The display apparatus 100 may play content files (e.g., video files, still image files, music files, document files, application files, etc.) stored in the memory 140, and may provide the content files to a user.

The user input interface 150 may transmit signals input by a user to the controller 170, or may transmit signals from the controller 170 to a user. For example, the user input interface 150 may receive or process control signals such as power on/off, channel selection, and screen setting from the remote-control device 200 or transmit control signals from the controller 170 to the remote-control device 200 according to various communication methods such as Bluetooth, Ultra Wideband (WB), ZigBee, Radio Frequency (RF), and IR communication methods.

In addition, the user input interface 150 may transmit, to the controller 170, control signals input from local keys (not shown) such as a power key, a channel key, a volume key, and a setting key.

Image signals that are image-processed by the controller 170 may be input to the display 180 and displayed as images corresponding to the image signals. In addition, image signals that are image-processed by the controller 170 may be input to an external output device through the external device interface 135.

Voice signals processed by the controller 170 may be output to the speaker 185. In addition, voice signals processed by the controller 170 may be input to the external output device through the external device interface 135.

Additionally, the controller 170 may control overall operations of the display apparatus 100.

In addition, the controller 170 may control the display apparatus 100 by a user command or an internal program input through the user input interface 150, and may access the network to download a desired application or application list into the display apparatus 100.

The controller 170 may output channel information selected by a user together with the processed image or voice signals through the display 180 or the speaker 185.

In addition, the controller 170 may output image signals or voice signals of an external device such as a camera or a camcorder, which are input through the external device interface 135, through the display 180 or the speaker 185, according to an external device image playback command received through the user input interface 150.

Moreover, the controller 170 may control the display 180 to display images, and may control the display 180 to display broadcast images input through the tuner 131, external input images input through the external device interface 135, images input through the network interface, or images stored in the memory 140. In this case, an image displayed on the display 180 may be a still image or video and also may be a 2D image or a 3D image.

Additionally, the controller 170 may play content stored in the display apparatus 100, received broadcast content, and external input content input from the outside, and the content may be in various formats such as broadcast images, external input images, audio files, still images, accessed web screens, and document files.

Moreover, the wireless communication interface 173 may perform wired or wireless communication with an external device. The wireless communication interface 173 may perform short-range communication with an external device. For this, the wireless communication interface 173 may support short-range communication by using at least one of Bluetooth™, Bluetooth Low Energy (BLE), Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB) technologies. The wireless communication interface 173 may support wireless communication between the display apparatus 100 and a wireless communication system, between the display apparatus 100 and another display apparatus 100, or between networks including the display apparatus 100 and another display apparatus 100 (or an external server) through wireless area networks. The wireless area networks may be wireless personal area networks.

Herein, the other display apparatus 100 may be a mobile terminal such as a wearable device (for example, a smart watch, a smart glass, and a head mounted display (HMD)) or a smartphone, which is capable of exchanging data (or inter-working) with the display apparatus 100. The wireless communication interface 173 may detect (or recognize) a wearable device capable of communication around the display apparatus 100.

Furthermore, if the detected wearable device is a device authenticated to communicate with the display apparatus 100, the controller 170 may transmit at least part of data processed in the display apparatus 100 to the wearable device through the wireless communication interface 173. Therefore, a user of the wearable device may use the data processed by the display apparatus 100 through the wearable device.

The display 180 may convert image signals, data signals, or on-screen display (OSD) signals, which are processed in the controller 170, or images signals or data signals, which are received in the external device interface 135, into R, G, and B signals to generate driving signals.

Furthermore, the display apparatus 100 shown in FIG. 1 is just one embodiment of the present disclosure and thus, some of the components shown may be integrated, added, or omitted according to the specification of the actually implemented display apparatus 100.

That is, if necessary, two or more components may be integrated into one component, or one component may be divided into two or more components. Additionally, a function performed by each block is to describe an embodiment of the present disclosure and its specific operation or device does not limit the scope of the present disclosure.

According to another embodiment of the present disclosure, unlike FIG. 1, the display apparatus 100 may receive images through the network interface 133 or the external device interface 135 and play them without including the tuner 131 and the demodulator 132.

For example, the display apparatus 100 may be divided into an image processing device such as a set-top box for receiving broadcast signals or contents according to various network services and a content playback device for playing content input from the image processing device.

In this case, an operating method of a display apparatus according to an embodiment of the present disclosure described below may be performed by one of the display apparatus described with reference to FIG. 1, an image processing device such as the separated set-top box, and a content playback device including the display 180 and the speaker 185.

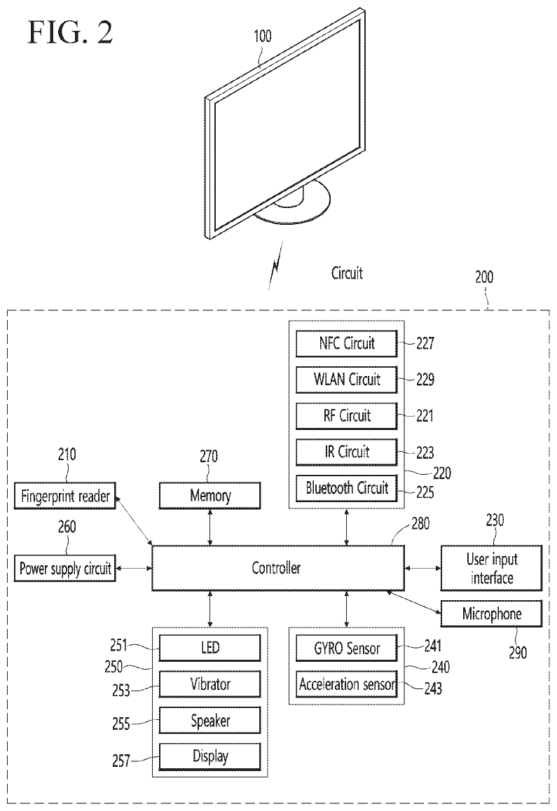

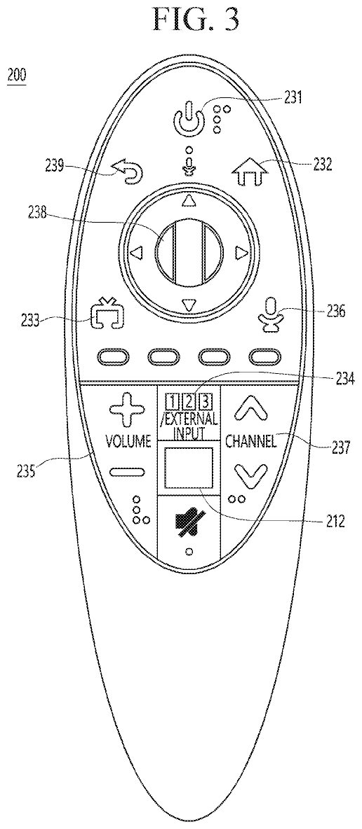

A remote-control device according to an embodiment of the present disclosure will be described with reference to FIGS. 2 and 3.

FIG. 2 is a block diagram illustrating a remote-control device according to an embodiment of the present disclosure, and FIG. 3 is a diagram illustrating an actual configuration of a remote-control device according to an embodiment of the present disclosure.

First, referring to FIG. 2, a remote-control device 200 may include a fingerprint recognition module 210, a wireless communication interface 220, a user input interface 230, a sensor 240, an output interface 250, a power supply circuit 260, a memory 270, a controller 280, and a microphone 290.

Referring to FIG. 2, the wireless communication interface 220 transmits/receives signals to/from an arbitrary any one of display apparatuss according to the above-mentioned embodiments of the present disclosure.

The remote-control device 200 may include a radio frequency (RF) circuit 221 capable of transmitting or receiving signals to or from the display apparatus 100 according to an RF communication standard, and an IR circuit 223 capable of transmitting or receiving signals to or from the display apparatus 100 according to an IR communication standard. In addition, the remote-control device 200 may include a Bluetooth circuit 225 capable of transmitting or receiving signals to or from the display apparatus 100 according to a Bluetooth communication standard. In addition, the remote-control device 200 may include an NFC circuit 227 capable of transmitting or receiving signals to or from the display apparatus 100 according to an NFC communication standard, and a wireless LAN (WLAN) circuit 229 capable of transmitting or receiving signals to or from the display apparatus 100 according to a WLAN communication standard.

In addition, the remote-control device 200 may transmit signals containing information on the movement of the remote-control device 200 to the display apparatus 100 through the wireless communication interface 220.

Moreover, the remote-control device 200 may receive signals transmitted from the display apparatus 100 through the RF circuit 221 and if necessary, may transmit a command for power on/off, channel change, and volume change to the display apparatus 100 through the IR circuit 223.

The user input interface 230 may be configured with a keypad, a button, a touch pad, or a touch screen. A user may operate the user input interface 230 to input a command relating to the display apparatus 100 to the remote-control device 200. If the user input interface 230 includes a hard key button, a user may input a command relating to the display apparatus 100 to the remote-control device 200 through the push operation of the hard key button. This will be described with reference to FIG. 3.

Referring to FIG. 3, the remote-control device 200 may include a plurality of buttons. The plurality of buttons may include a fingerprint recognition button 212, a power button 231, a home button 232, a live button 233, an external input button 234, a volume control button 235, a voice recognition button 236, a channel change button 237, an OK button 238, and a back button 239.

The fingerprint recognition button 212 may be a button for recognizing a user's fingerprint. According to an embodiment of the present disclosure, the fingerprint recognition button 212 may perform a push operation and receive a push operation and a fingerprint recognition operation.

The power button 231 may be a button for turning on/off the power of the display apparatus 100.

The home button 232 may be a button for moving to the home screen of the display apparatus 100.

The live button 233 may be a button for displaying live broadcast programs.

The external input button 234 may be a button for receiving an external input connected to the display apparatus 100.

The volume control button 235 may be a button for controlling a volume output from the display apparatus 100.

The voice recognition button 236 may be a button for receiving user's voice and recognizing the received voice.

The channel change button 237 may be a button for receiving broadcast signals of a specific broadcast channel.

The OK button 238 may be a button for selecting a specific function, and the back button 239 may be a button for returning to a previous screen.

FIG. 2 is described again.

If the user input interface 230 includes a touch screen, a user may touch a soft key of the touch screen to input a command relating to the display apparatus 100 to the remote-control device 200. In addition, the user input interface 230 may include various kinds of input interfaces operable by a user, for example, a scroll key and a jog key, and this embodiment does not limit the scope of the present disclosure.

The sensor 240 may include a gyro sensor 241 or an acceleration sensor 243. The gyro sensor 241 may sense information on the movement of the remote-control device 200.

For example, the gyro sensor 241 may sense information on an operation of the remote-control device 200 on the basis of x, y, and z axes and the acceleration sensor 243 may sense information on a movement speed of the remote-control device 200. Moreover, the remote-control device 200 may further include a distance measurement sensor that senses a distance with respect to the display 180 of the display apparatus 100.

The output interface 250 may output image or voice signals in response to the operation of the user input interface 230, or may output image or voice signals corresponding to signals transmitted from the display apparatus 100.

A user may recognize whether the user input interface 230 is operated or the display apparatus 100 is controlled through the output interface 250.

For example, the output interface 250 may include an LED module 251 for flashing, a vibration module 253 for generating vibration, a speaker 255 for outputting sound, or a display module 257 for outputting an image, if the user input interface 230 is manipulated or signals are transmitted/received to/from the display apparatus 100 through the wireless communication interface 220.

Additionally, the power supply circuit 260 supplies power to the remote-control device 200 and if the remote-control device 200 does not move for a predetermined time, stops the power supply, so that power waste may be reduced.

The power supply circuit 260 may resume the supply of power if a predetermined key provided at the remote-control device 200 is operated.

The memory 270 may store various kinds of programs and application data required to control or operate the remote-control device 200.

If the remote-control device 200 transmits/receives signals wirelessly through the display apparatus 100 and the RF circuit 221, the remote-control device 200 and the display apparatus 100 transmits/receives signals through a predetermined frequency band.

The controller 280 of the remote-control device 200 may store, in the memory 270, information on a frequency band for transmitting/receiving signals to/from the display apparatus 100 paired with the remote-control device 200 and refer to it.

The controller 280 controls general matters relating to the control of the remote-control device 200. The controller 280 may transmit a signal corresponding to a predetermined key operation of the user input interface 230 or a signal corresponding to the movement of the remote-control device 200 sensed by the sensor 240 to the display apparatus 100 through the wireless communication interface 220.

In addition, the microphone 290 of the remote-control device 200 may acquire voice.

A plurality of the microphone 290 may be provided.

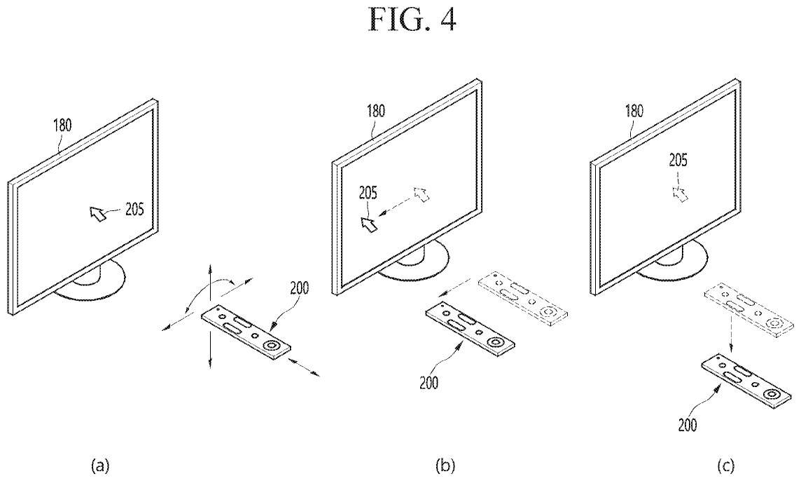

Next, FIG. 4 is described.

FIG. 4 is a diagram illustrating an example of utilizing a remote-control device according to an embodiment of the present disclosure.

FIG. 4(a) illustrates that a pointer 205 corresponding to the remote-control device 200 is displayed on the display 180.

A user may move or rotate the remote-control device 200 vertically or horizontally. The pointer 205 displayed on the display 180 of the display apparatus 100 corresponds to a movement of the remote-control device 200. Since the corresponding pointer 205 is moved and displayed according to a movement on a 3D space as show in the drawing, the remote-control device 200 may be referred to as a spatial remote-control device.

FIG. 4(b) illustrates that if a user moves the remote-control device 200, the pointer 205 displayed on the display 180 of the display apparatus 100 is moved to the left according to the movement of the remote-control device 200.

Information on a movement of the remote-control device 200 detected through a sensor of the remote-control device 200 is transmitted to the display apparatus 100. The display apparatus 100 may calculate the coordinates of the pointer 205 from the information on the movement of the remote-control device 200. The display apparatus 100 may display the pointer 205 to match the calculated coordinates.

FIG. 4(c) illustrates that while a specific button in the remote-control device 200 is pressed, a user moves the remote-control device 200 away from the display 180. Thus, a selected region in the display 180 corresponding to the pointer 205 may be zoomed in and displayed in an enlarged size.

On the other hand, if a user moves the remote-control device 200 close to the display 180, a selection area in the display 180 corresponding to the pointer 205 may be zoomed out and displayed in a reduced size.

Meanwhile, if the remote-control device 200 is moved away from the display 180, a selection area may be zoomed out and if the remote-control device 200 is moved closer to the display 180, a selection area may be zoomed in.

Additionally, if a specific button in the remote-control device 200 is pressed, recognition of a vertical or horizontal movement may be excluded. That is, if the remote-control device 200 is moved away from or closer to the display 180, the up, down, left, or right movement cannot be recognized and only the back and forth movement may be recognized. While a specific button in the remote-control device 200 is not pressed, only the pointer 205 is moved according to the up, down, left or right movement of the remote-control device 200.

Moreover, the moving speed or moving direction of the pointer 205 may correspond to the moving speed or moving direction of the remote-control device 200.

Furthermore, a pointer in this specification means an object displayed on the display 180 in response to an operation of the remote-control device 200. Therefore, in addition to the arrow form displayed as the pointer 205 in the drawing, various forms of objects are possible. For example, the above concept includes a point, a cursor, a prompt, and a thick outline. Then, the pointer 205 may be displayed in correspondence to one point of a horizontal axis and a vertical axis on the display 180 and also may be displayed in correspondence to a plurality of points such as a line and a surface.

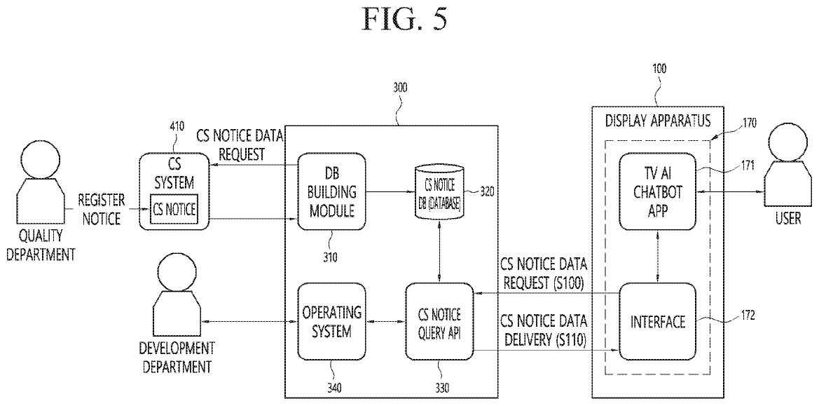

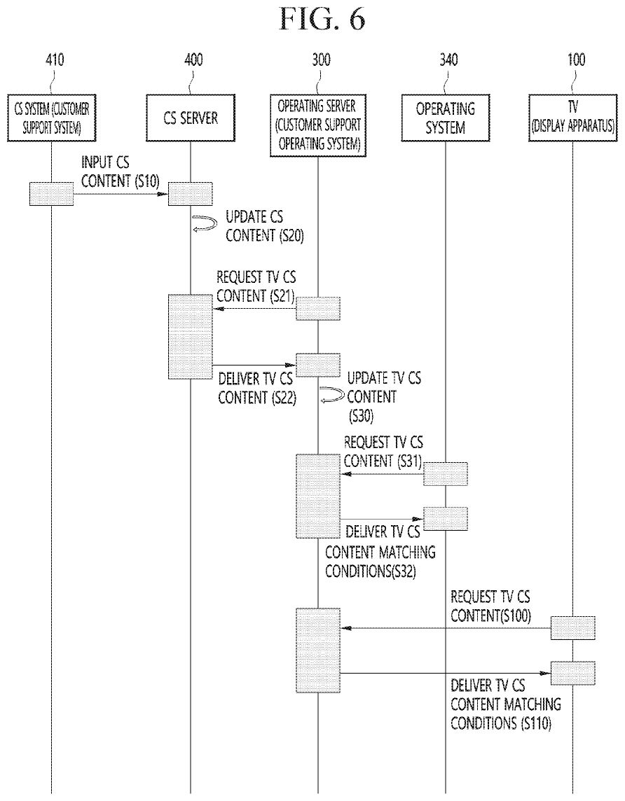

FIG. 5 is a block diagram illustrating a detailed configuration of a display apparatus according to an embodiment of the present disclosure. FIG. 6 is a ladder diagram illustrating an operating process of a display apparatus according to an embodiment of the present disclosure.

Referring to FIG. 5, an example of a display apparatus 100 may be a TV receiving a digital TV service using a wired or wireless communication network. Digital TV services, such as IPTV and smart TV services, may provide various additional services based on interactivity. Hereinafter, an embodiment of the present disclosure will be described by taking an example in which the display apparatus 100 is a TV. However, the present disclosure is not limited thereto.

As described above, the display apparatus 100 may include a display 180 that processes and displays an image signal. An image signal image-processed by the controller 170 may be input to the display 180 and displayed as an image corresponding to the corresponding image signal.

The controller 170 may include a customer support application 171 and an interface 172 connected to the customer support application 171.

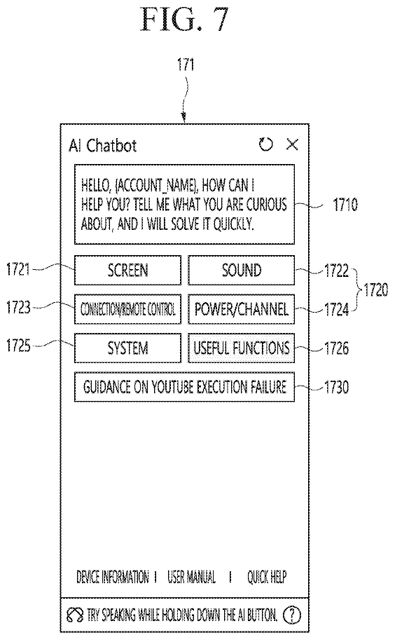

For example, the customer support application 171 may be a computer program that supports customer support. For example, the customer support application 171 may exchange information with a user or a viewer (hereinafter, collectively referred to as a user) through voice or text. An example of such a customer support application 171 may be implemented as a chatbot. The customer support application 171 may be executed by a user's request and displayed on the display 180 (see FIG. 7).

A chatbot is a computer program that performs a specific task while conversing with a person through voice or text, and may also be referred to as a talkbot, a chatterbox, or a bot. Such a chatbot is an AI-based virtual assistant and may be designed to simulate human-like conversation. Hereinafter, an embodiment in which the customer support application 171 is implemented as a chatbot will be described. However, the present disclosure is not limited thereto.

The controller 170 of the display apparatus 100 may be connected to a customer support operating system 300 through the interface 172.

The controller 170 may be connected to the customer support operating system 300 to receive or update customer support content related to the display apparatus 100.

For example, the customer support operating system 300 may be implemented as a server. Such a server may include a database (DB) 320 for storing customer support content, a DB building module 310 for building the DB, an operating system 340 for operating the DB building module 310 and the DB 320, and an API 330 connected to the interface 172 of the controller 170 so that the content stored in the DB 320 can be queried.

The customer support application 171 may receive or update customer support content from the customer support operating system 300 through the interface 172 and the API 330. Such customer support content may be received or updated by a data request (S100). That is, data may be delivered through the API 330 in response to the data request (S100).

Customer Service or Customer Support (CS) content may include frequently occurring customer service inquiries related to the display apparatus 100 and responses to the inquiries.

In this case, the frequently occurring customer service inquiries and the responses to the inquiries may be provided as a notice of the customer support application (CS notice). For example, a chatbot app (customer support application 171) of the display apparatus 100 may provide, as a notice, frequently occurring customer service inquiries related to the display apparatus 100 and responses to the inquiries.

In addition, the frequently occurring customer service inquiries related to the display apparatus 100 and the responses to the inquiries may include at least one of a solution related to the corresponding customer service inquiry and guidance for a follow-up action.

An inquiry related to the display apparatus 100 may be an inquiry specific to a model of the display apparatus 100. For example, an inquiry related to the display apparatus 100 may be an inquiry related to at least one of a model name, a serial number, and a software version of the display apparatus 100.

The customer support operating system 300 may receive customer support content from a customer support system (CS system; 410). The CS notice described above may be registered after being processed by a quality department. Such a customer support system 410 may operate a CS server 400 (see FIG. 6).

Meanwhile, the customer support operating system 300 may be operated by a development department. The customer support operating system 300 may request and receive CS notice data from the customer support system 410.

Referring to FIG. 6, customer support (CS) content may be delivered to the CS server 400 by the customer support system 410, and the CS content may be input to the CS server 400 (step S10).

A CS content update process (step S20) may be performed in the CS server 400. Such a CS content update process (step S20) may be performed periodically.

The operating server 300 (customer support operating system) may perform a CS content request (step S21) to the CS server 400, and in response thereto, the CS content may be delivered to the operating server 300 (step S22). The CS content request (step S21) may be performed periodically. For example, the CS content request (step S21) may be performed once a day.

Accordingly, the CS content may be updated in the operating system 340 (step S30). Similarly, the operating system 340 may perform a CS content request (step S31) to the operating server 300, and in response thereto, the CS content may be delivered to the operating system 340 (step S32).

In this case, the CS content request (step S31) may be performed based on a UI filter condition, and CS content matching the corresponding condition may be delivered to the operating system 340 (step S32).

Thereafter, the display apparatus 100 (TV) may perform a CS content request (step S100) to the operating server 300, and in response thereto, the CS content may be delivered to the display apparatus 100 (TV) (step S110).

In this case, the CS content request (step S100) may be performed based on a TV platform and a country condition, and CS content matching the corresponding platform and condition may be delivered to the display apparatus 100 (TV) (step S110).

FIG. 7 is an exemplary diagram illustrating an example of a customer support application interface of a display apparatus according to an embodiment of the present disclosure.

Referring to FIG. 7, as described above, an example of the customer support application 171 may be implemented as a chatbot. The customer support application 171 may be executed by a user's request and displayed on the display 180.

An AI chatbot 171 may be implemented and displayed on the display 180 as shown. The chatbot 171 may display, for example, a plurality of categories as main items 1720. For example, items related to a screen 1721, sound 1722, connection/remote control 1723, power/channel 1724, a system 1725, and other useful functions 1726 may be displayed as the main items 1720.

Meanwhile, a CS notice 1730 may be displayed on one side, for example, a lower side, of the main items 1720. As described above, such a CS notice may be frequently occurring customer service inquiries and responses to the inquiries.

In addition, a user and greeting comment 1710 may be displayed on the other side, for example, an upper side, of the main items 1720.

The CS notice 1730 is a notice provided by the server (operating server 300) when a problem that continuously leads to a CS inquiry, such as a software or hardware problem, occurs, and a context-aware suggested response area may be used in the same manner. For example, notice content, a providing location, and a posting period may be managed by the CS system 410.

When the CS notice and the context-aware suggested response overlap, the CS notice may be preferentially provided.

Meanwhile, when there are two or more notices provided at the same location, a recently registered notice may be provided with priority.

When the CS notice 1730 is selected (clicked), it may be expanded to provide full content.

Upon expansion, a focus may be provided through a button such as “Do not show again.”

In the case that the user restarts the conversation or closes the chatbot app after selecting “Do not show again,” the corresponding notice may no longer be provided. For example, even In the case that the notice posting period remains, the corresponding display apparatus 100 may no longer provide the notice.

As described above, by using the TV chatbot, frequently occurring CS inquiries can be provided as a notice in the chatbot. In this case, the notice can be preemptively provided only to users who have experienced symptoms related to the corresponding CS inquiry.

Accordingly, the latest CS notice content can be quickly provided by the chatbot of the TV. In this case, the CS notice can be preemptively provided by specifying a user who has inquired about CS content. For example, a platform code, SoC chip information, and a SW version may be checked to expose a notice specifically to the corresponding model.

Meanwhile, the chatbot may guide a response schedule and/or a temporary solution.

Therefore, frequently occurring customer service inquiries related to the display apparatus 100 and responses to the inquiries can be quickly provided.

Meanwhile, a user can easily submit a solution or content related to a software or hardware problem.

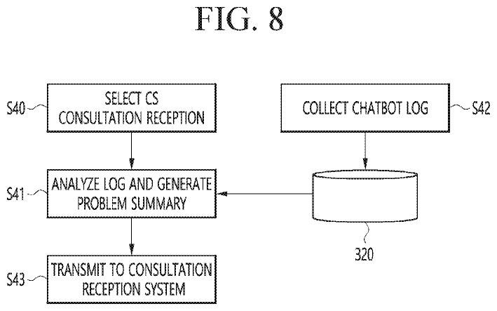

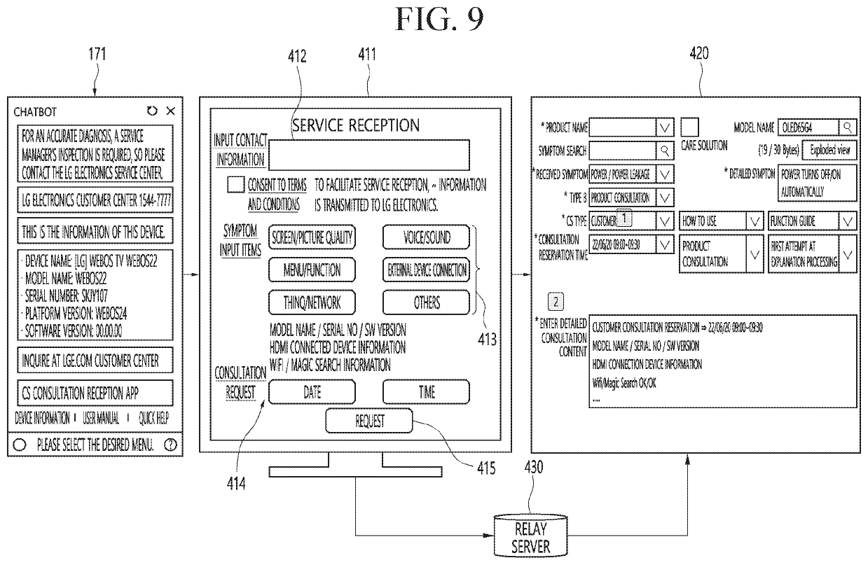

FIG. 8 is a flowchart illustrating an operating process of a display apparatus according to an embodiment of the present disclosure. FIG. 9 is an exemplary diagram illustrating an example of a customer support operating system associated with a display apparatus according to an embodiment of the present disclosure.

As described above, the controller 170 of the display apparatus 100 may receive or update customer support content related to the display apparatus 100 from the customer support operating system 300.

Accordingly, frequently occurring customer service inquiries related to the display apparatus 100 and responses to the inquiries can be provided.

Information accumulated according to such a process may be provided to a consultation reception system 411, and the consultation reception system 411 may provide customer support more quickly and easily by using such information.

Referring to FIG. 8, when a user selects CS consultation reception (step S40), an item selected by the user in the customer support application 171 and a history of actions taken by the user may be stored as a log (step S42). The log may be stored in the DB 320.

Accordingly, the customer support application 171 (chatbot) or the customer support operating system 300 may analyze the collected log to generate summary information (step S41). In this case, LLM (large language model) analysis may be performed on the actions attempted by the user and problem symptoms.

Thereafter, the generated summary information may be transmitted to the customer support operating system 300 (step S43). When the summary information is generated in the customer support operating system 300, the summary information may be transmitted to the building module 310 that manages the DB 320.

Referring to FIG. 9, the customer support application 171 may provide a tool (consultation reception system 411) for collecting an additional request from a user related to the customer support content.

Technical details specific to the display apparatus 100 may be provided to the tool 411. For example, the technical details specific to the display apparatus 100 may include at least one of a model name, a serial number, and a software version of the display apparatus 100. At least one of the model name, the serial number, and the software version of the display apparatus 100 may be referred to as device information.

Meanwhile, information on a previous repair history of the display apparatus 100 related to the corresponding device information may be further provided to the consultation reception system 411 based on the technical details (device information) specific to the display apparatus 100. For example, the consultation reception system 411 or the customer support operating system 300 may query the previous repair history of the display apparatus 100 based on the device information.

On the other hand, customer information related to the display apparatus 100 may be additionally provided to the consultation reception system 411. For example, the consultation reception system 411 or the customer support operating system 300 may additionally collect customer information of a customer who owns the display apparatus 100 in connection with collecting information on the repair history of the display apparatus 100.

In collecting such information, the consultation reception system 411 or the customer support operating system 300 may request consent from the customer (user) and collect the information when the customer consents.

Meanwhile, as an exemplary embodiment, querying or collecting such information may be performed in the customer support application 171 or the customer support system 410 described above.

A user may input a symptom experienced by the user and request a consultation through the consultation reception system 411. In this case, the consultation reception system 411 may display items identical or similar to the main items 1720 of the chatbot 171.

Such an additional request from the user may be provided to the customer support operating system 300.

When a consultation is requested by the user through the consultation reception system 411 as described above, a consultation screen 420 may be provided in the CS system 410. Such a process may be performed through a relay server 430.

Accordingly, a counselor can identify the user's needs in advance through the consultation screen 420, and the consultation can proceed quickly and effectively.

As described above, since basic items (device information/symptoms, etc.) of the consultation reception system 411 are automatically input and displayed on the consultation screen 420, the counselor can check analyzed content in advance when starting the consultation to identify items selected by the user and a history of attempted actions in advance, and then proceed with a more accurate and prompt consultation.

For example, since information on the previous repair history and customer information are already collected in the consultation reception system 411, the counselor can proceed with the consultation while having previously identified information on the device used and experienced by the user.

Accordingly, it is possible to reduce call waiting time when receiving customer support requests and to quickly provide information during a consultation with a counselor.

Operations performed by the controller 170 as described above or operations performed in the customer support operating system 300 may be recorded in a computer-readable storage medium as computer program instructions. For example, the computer-readable storage medium may store program instructions for causing the controller 170 or the customer support operating system 300 (server) according to an embodiment of the present disclosure to operate.

The above description is merely illustrative of the technical idea of the present disclosure, and various modifications and variations can be made by those skilled in the art without departing from the essential characteristics of the present disclosure.

Therefore, the embodiments disclosed in the present disclosure are intended to explain rather than limit the technical idea of the present disclosure, and the scope of the technical idea of the present disclosure is not limited by these embodiments. The scope of protection of the present disclosure should be interpreted by the following claims, and all technical ideas within the scope equivalent thereto should be interpreted as being included in the scope of rights of the present disclosure.

What is claimed is:

1. A display apparatus, comprising:
a display; and
a controller configured to process an image signal and display the processed image signal on the display,
wherein the controller is further configured to:
execute and display a customer support application on the display;
provide information regarding the display apparatus through the customer support application; and
further provide customer support content related to the display apparatus through the customer support application.

2. The display apparatus of claim 1, wherein the customer support content includes frequently occurring customer service inquiries related to the display apparatus and responses to the inquiries.

3. The display apparatus of claim 2, wherein the frequently occurring customer service inquiries and the responses to the inquiries are provided as a notice of the customer support application.

4. The display apparatus of claim 3, wherein the responses include at least one of a solution related to the frequently occurring customer service inquiries and guidance for a follow-up action.

5. The display apparatus of claim 1, wherein the controller is further configured to receive or update the customer support content related to the display apparatus.

6. The display apparatus of claim 1, wherein the customer support application provides a tool for collecting an additional request from a user related to the customer support content.

7. The display apparatus of claim 6, wherein technical details specific to the display apparatus are provided to the tool.

8. The display apparatus of claim 7, wherein the technical details specific to the display apparatus include at least one of a model name, a serial number, and a software version of the display apparatus.

9. The display apparatus of claim 7, wherein the additional request from the user is provided to a customer support operating system.

10. The display apparatus of claim 6, wherein device information including at least one of a model name, a serial number, and a software version of the display apparatus is provided to the tool.

11. The display apparatus of claim 10, wherein information on a previous repair history of the display apparatus related to the device information is further provided to the tool based on the device information.

12. The display apparatus of claim 6, wherein customer information related to the display apparatus is provided to the tool, and the customer information is collected when the customer consents.

13. The display apparatus of claim 1, wherein the controller is further configured to:
store, as a log, an item selected by the user in the customer support application and a history of actions taken by the user;
analyze the collected log to generate summary information; and
transmit the summary information to a customer support operating system.

14. A method for operating a display apparatus using a customer support application executed by a controller of the display apparatus in connection with a customer support operating system, the method comprising:
receiving or updating customer support content related to the display apparatus from the customer support operating system;
providing the customer support content related to the display apparatus;
storing, as a log, an item selected by a user in the customer support application and a history of actions taken by the user;
analyzing the collected log to generate summary information; and
transmitting the summary information to the customer support operating system.

15. The method of claim 14, wherein the customer support content includes frequently occurring customer service inquiries related to the display apparatus and responses to the inquiries.

16. The method of claim 15, wherein the frequently occurring customer service inquiries and the responses to the inquiries are provided as a notice of the customer support application.

17. The method of claim 15, wherein the responses include at least one of a solution related to the frequently occurring customer service inquiries and guidance for a follow-up action.

18. The method of claim 14, further comprising providing a tool for collecting an additional request from the user related to the customer support content.

19. A computer-readable storage medium storing program instructions for causing a controller to perform operations, the operations comprising:
receiving or updating customer support content related to a display apparatus from a customer support operating system;
providing the customer support content related to the display apparatus;
storing, as a log, an item selected by a user in a customer support application and a history of actions taken by the user;
analyzing the collected log to generate summary information; and
transmitting the summary information to the customer support operating system.
